(19) United States
(12) Patent Application Publication
(10) Pub. No.: US 2015/0153485 A1
(43) Pub. Date: Jun. 4, 2015

(54) COATED MIRRORS FOR USE IN LASER-BASED DENTAL TREATMENT SYSTEMS AND METHODS OF MAKING SUCH MIRRORS

(71) Applicant: Convergent Dental, Inc., Natick, MA (US)

(72) Inventor: Nathan P. Monty, Shrewsbury, MA (US)

(21) Appl. No.: 14/554,459

(22) Filed: Nov. 26, 2014

Related U.S. Application Data
(60) Provisional application No. 61/909,902, filed on Nov. 27, 2013.

(51) Int. Cl. G02B 1/18; A61C 1/00; C23C 14/34; G02B 5/08

(52) U.S. Cl. CPC G02B 1/18; G02B 5/0808; A61C 1/0046; C23C 14/34

(57) ABSTRACT

A reflective device disposable within a hand piece or other housing for directing a laser beam toward a treatment area includes a substrate, a first layer above the substrate, and a second layer above the first layer, and lacks a reflective dielectric layer. The second layer may have a hardness of at least about 120 Knoop, and the combination of transmissive and reflective properties in the first layer and the second layer can provide reflection of light wavelengths ranging from about 380 nm to about 12,000 nm. Reflective devices according to other constructions are also described.

### CROSS-REFERENCE TO RELATED APPLICATIONS

This application claims benefit of priority to U.S. Provisional Patent Application No. 61/909,902, entitled “Coated Mirrors for Use with Laser-Based Dental Treatment Systems,” filed on Nov. 27, 2013, the contents of which are incorporated herein by reference in their entirety.

### FIELD OF THE INVENTION

The present disclosure generally relates to mirrors and, in particular, to mirrors that have a protective coating and that are suitable for use in laser-based systems.

### BACKGROUND OF THE INVENTION

Lasers are known to be useful in several hard and soft tissue dental procedures, including: removing decay, cutting, drilling or shaping hard tissue, and removing or cutting soft tissue. A tooth has three layers. The outermost layer is the enamel which is the hardest and forms a protective layer for the rest of the tooth. The middle and bulk of the tooth is made up of dentin, and the innermost layer is the pulp. The enamel and dentin are similar in composition and are roughly at least 70% mineral by weight, which is generally carbonated hydroxyapatite, while the pulp contains vessels and nerves. Laser radiations at a wavelength between 9.3-9.6 micrometer (μm) range are well absorbed by the hydroxyapatite that is typically a major component of teeth and bones, making such lasers efficient in the removal of hard tissue. Lasers in the above stated wavelength range and that have sufficient power for use in dental and/or surgical procedures can be manufactured at a low price to allow for commercial use of such lasers.

Lasers are known to be useful in the removal of dental material generally without the need for local anesthetic that is usually required when a similar procedure is performed using a conventional drill or bur. Moreover, lasers generally do not make the noises and vibrations that are associated with dental drills. At least for these reasons, it has been the hope of many in the dental industry that lasers would replace the drill because they may reduce the anxiety and fear generally associated with conventional dental treatment.

In addition to the laser beam used for treatment (e.g., ablation), laser-based dental systems may also use an aiming laser beam that has a wavelength in the visible spectrum. The wavelength of an aiming laser is often 532 nm (green) or 650 nm (red). A doctor, dentist, or other trained practitioner may position and guide a handpiece into a person's mouth. The handpiece is connected, e.g., through a flexible or otherwise articulated structure, such as a structure containing an optical fiber light guide, to a laser source. To generate efficiently laser radiation at wavelengths approximately in the 9.3-9.6 μm range, in the form of pulses having widths in a range from about 1 μs up to about 30 μs, or up to about 100 μs, or up to about 250 μs, or even up to about 500 μs, a radio frequency (RF) excited CO₂ laser operated using gas at a pressure in a range of about 260 Torr to about 600 Torr may be used. Such a laser is described in U.S. Patent Application Pub. No. 2011-0189628A1, the entire contents of which are incorporated herein by reference. Certain Erbium lasers may also be used.

In general, the handpiece contains optical elements including lenses and mirrors that are used to focus and steer the laser beam to a selected focal point. For ergonomic reasons, the handpiece often has an angled tip which permits the user to have more natural control over the application of the laser beam to the target region on or in a person's body. See, for example, U.S. Patent Application Pub. No. US2013/0059264A1, the entire disclosure of which is hereby incorporated herein by reference in its entirety.

When an angled tip is used with a laser handpiece, a turning mirror is generally the final optical element in the laser beam path before the beam exits the handpiece from an orifice thereof. The length of the tip is typically about 0.5-2 inches (or about 1-5 cm), or up to 3 inches (or about 7 cm). Therefore, in a typical dental/surgical procedure, the turning mirror tends to be located close to the treatment site, i.e., at a distance of about 0.5-3 inches (about 1 to 7 cm) from the surface of the tissue to be treated. At this distance, debris from a cut zone, e.g., pieces of enamel which can be hot, can reach the mirror surface and adhere thereto, causing mirror contamination and/or damage, that can adversely affect directing the laser beam to the targeted treatment area.

Some mirrors used in dental treatment include a silicon (Si)-based substrate and a broad-band reflector. If used in laser-based dental treatment, hot pieces of enamel that are cut by the laser irradiation can adhere to the reflector and may melt thereon, decreasing the reflectivity of the mirror. The ablatively removed hard tissue adhering to the mirror's surface can cause hot spots on the mirror surface. These hot spots can result in permanent damage to the mirror and in rapid degradation of the performance of the laser beam used for ablation. As such, this type of mirror typically has only up to about one minute of use before the mirror must be cleaned or replaced.

Various autoclavable mirrors, that can be sterilized, generally do not efficiently remove heat from the mirror surface and, hence, may also be damaged quickly in laser-based dental treatment, e.g., due to hot debris emitted from the cut zone. Some mirrors, such as a mirror 100 depicted schematically in FIG. 1, include a top layer 106 of a coating of an abrasion-resistive material, e.g., to protect the reflective layers 104 disposed below the coating 106 and on a substrate 102. These mirrors usually include one or more dielectric reflectors 104 that are customized to reflect radiation only in a selected narrow wavelength range with reflectivity greater than 99%. The dielectric layers generally do not conduct heat and, as such, these mirrors can also be easily and quickly damaged during laser based dental and/or surgical treatment.

### SUMMARY OF THE INVENTION

Various embodiments described herein feature mirrors that are adapted for laser-based dental treatment and that do not require frequent cleansing or replacement. For example, mirrors according to some embodiments can be used effectively for up to about 10 minutes or even up to about 20 minutes of lasing time, e.g., the total time for which the mirror receives and reflects laser radiation with sufficient reflectivity, e.g., at least 40%, or 50%, or 60%, or 75% reflectivity, so that transmission of the laser beam to a treatment area is not significantly adversely affected and cleansing and/or replacement of the mirror is not necessary. This is achieved, at least in part, using a combination of a reflective layer and a protective coating that, together, can reflect both visible light (e.g., light having wavelengths in a range from about 360 nm up to about 780 nm) and mid-infra-red radiation (e.g., radiation having wavelengths in a range from about 780 nm up to about 12,000 nm). In addition, one or more of the coating, the reflective layer(s), and the substrate of the mirror are selected such that the mirror can conductively or diffusively dissipate heat from any debris deposited on the mirror surface, e.g., to reduce or eliminate hot spots on the reflective layers. Further to minimize contamination of the mirror, the outermost coating/layer may be hydrophobic.

Accordingly, in one aspect, a reflective device, that may be placed within a hand piece or other housing for directing a laser beam to a treatment area, features a substrate, a first layer above the substrate, and a second layer above the first layer. The second layer has a hardness of at least about 120 Knoop, and the combination of transmissive and reflective properties in the first layer and the second layer provides reflection of light wavelengths ranging from about 380 nm to 12,000 nm. The reflective device lacks a reflective dielectric layer that can adversely affect thermal conductivity and/or diffusivity of the reflective device.

In accordance with an embodiment of the invention, the substrate is a thermally conductive and/or diffusive material, which may be at least as thermally conductive and/or diffusive as silicon. In some embodiments, the substrate is copper. The substrate may have a thickness between about 0.5 mm and 1.0 mm. The reflective device may also include a metallic, adhesive layer between the substrate and the first layer, which adhesive may include nickel.

In certain embodiments, the first layer has a gold layer and/or a silver layer, and the first layer may have a thickness between about 100 nm and 500 nm. The second layer may include a quartz layer, a sapphire layer, and/or a diamond-like carbon (DLC) layer, and the second layer may have a thickness between about 50 nm and 500 nm. In some embodiments, the second layer has a hydrophobic layer, which may include fluoro-alkyl silane (FAS). The first layer may include a first material adapted to reflect radiation within a first range of wavelengths (e.g., within a visible to infra-red range of wavelengths) while the second layer includes a second material that may reflect no radiation or within a second range of wavelengths (e.g., a visible range of wavelengths) different from the first range while transmitting radiation within an infra-red range of wavelengths, the layers thereby in combination reflecting radiation over a visible to infra-red range of wavelengths.

In another aspect, the invention relates to a reflective device that may be placed within a hand piece or other housing to direct a laser beam to a treatment area. The device includes a substrate, a first layer above the substrate, and a second layer above the first layer. The second layer includes a hydrophobic layer, and the combination of the first layer the second layer provides reflection of light in wavelengths ranging from about 380 nm to about 12,000 nm. In accordance with one embodiment of the foregoing aspect, the substrate includes silicon.

In yet another aspect, the invention relates to a method of manufacturing a reflective device that may be placed within a hand piece or other housing for directing a laser beam to a treatment area. The method includes bonding a non-adhesive, reflective layer to a substantially non-transparent, thermally conductive and/or diffusive substrate and depositing a coating over the reflective layer, without depositing and/or forming a reflective dielectric layer therebetween. The layers and the substrate are bonded so that the reflective device can reflect light at wavelengths ranging from about 380 nm up to about 12,000 nm.

In accordance with one embodiment of the foregoing aspect, the bonding step includes plating and/or sputtering. The bonding step may include plating an adhesive, intermediary layer to the substrate and plating the reflective layer to the intermediary layer. A hydrophobic material may be added to the coating as part of the method.

In still another aspect, the invention relates to a reflective device manufactured according to the method just described, particularly by bonding a non-adhesive, reflective layer to a substantially non-transparent, thermally conductive and/or diffusive substrate and depositing a coating on the reflective layer.

In still yet another aspect, the invention relates to a reflective device that may be placed within a hand piece or other housing for directing a laser beam to a treatment area. The reflective device includes a substantially non-transparent, thermally conductive and/or diffusive substrate, a non-adhesive, reflective layer above the substrate, and a coating above the reflective layer. The reflective device lacks a reflective dielectric layer.

In another aspect, the invention relates to a reflective device that may be placed within a hand piece or other housing for directing a laser beam to a treatment area. The reflective device includes a substantially non-transparent substrate, a reflective layer above the substrate, and a coating with a hydrophobic layer above the reflective layer.

In another aspect, a system for dental treatment includes a radio frequency (RF) excited CO₂ laser filled with gas at a pressure in a range of about 260 to 600 Torr, for generating a laser beam. The system also includes a hand piece in optical communication with the laser for directing the laser beam to a treatment area. A reflective device is disposed within the hand piece, and the reflective device includes a substrate. A first layer is disposed above the substrate, and a second layer is disposed above the first layer. The second layer has a hardness of at least about 120 Knoop. The reflective device lacks a reflective dielectric layer and the first layer and the second layer are selected such that the combination thereof provides reflection of light wavelengths ranging from about 380 nm to about 12,000 nm.

In another aspect, a reflective device, that can be disposed within a hand piece for directing a laser beam toward a treatment area, includes a reflective substrate and a protective layer disposed over the substrate. The substrate may be thermally conductive. In some embodiments, the substrate can be a polished metallic layer. The protective layer has a hardness of at least about 120 Knoop. The reflective device lacks a reflective dielectric layer. The materials and thickness of the substrate and the protective layer are selected such that a combination of the reflective substrate and the protective layer provides reflection of radiation at wavelengths ranging from about 380 nm to about 12,000 nm. The combination has a reflectivity of at least about 50% at wavelengths in the visible range, e.g., wavelengths ranging from approximately 380 nm up to approximately 720 nm. The combination has a reflectivity of at least about 85% in the mid-to-far infra-red spectrum, e.g., at wavelengths ranging from approximately 720 nm up to approximately 12,000 nm. The tolerance of the ranges can be 1 nm, 5 nm, 10 nm, 50 nm, 100 nm, etc. During the course of operation, the efficiency may degrade to about 50% and, during the course of a single dental procedure, the average mirror efficiency may be about 75%. A tolerance for mirror efficiency can be about 1%, 2%, 10%, 20%, etc. The reflective device lacks a reflective dielectric layer.

As can be seen from the above, it is an object of certain embodiments of the present invention to provide a laser mirror with a durable front layer. It is an object of certain embodiments of the present invention to provide a laser mirror with a hydrophobic front layer. It is an object of certain embodiments of the present invention to provide a high degree of reflection over wavelengths ranging from about 380 nm up to about 12,000 nm. It is an object of certain embodiments of the present invention to be highly thermally conductive and/or diffusive. It is a feature of certain embodiments to have a front layer containing DLC and hydrophobic fluorine compounds. It is a feature of certain embodiments of the present invention to have a layer which reflects visible light and a layer that reflects infra-red light, and does not include a reflective dielectric layer that can minimize the thermal conductivity/diffusivity of the mirror structure. It is a feature of certain embodiments of the present invention to have a reflective layer of noble metal. It is a feature of certain embodiments of the present invention to have a copper substrate.

### BRIEF DESCRIPTION OF THE FIGURES

Various features and advantages of the present invention, as well as the invention itself, can be more fully understood from the following description of the various embodiments, when read together with the accompanying drawings, in which:

FIG. 1 depicts a conventional high reflectivity multi-layer dielectric reflector having a silicon (Si) substrate;

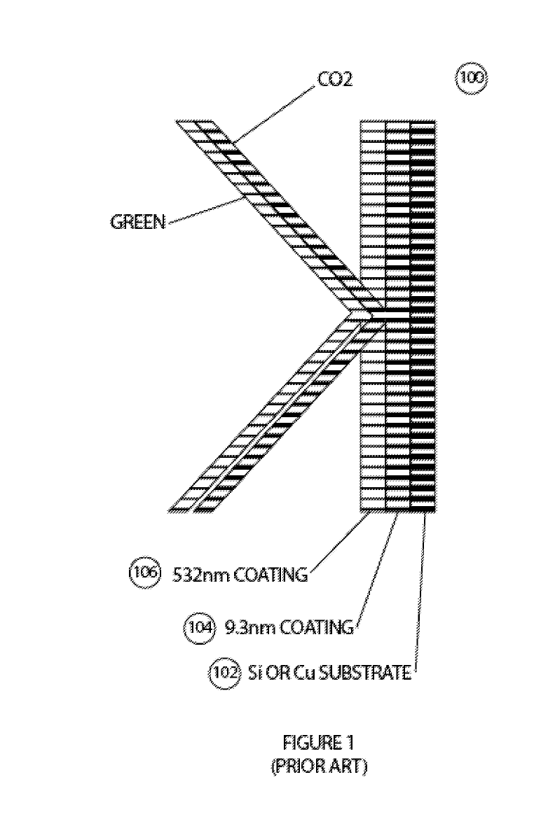

FIG. 2 depicts a laser-based dental treatment system using a mirror according to one embodiment;

FIG. 3 schematically depicts a wide band coating covered by a generally non-reflective over-coating for protection, on a substrate, according to various embodiments; and

FIG. 4 schematically depicts a reflective coating (e.g., gold) covered by a reflective coating, on a substrate, according to various embodiments.

### DETAILED DESCRIPTION

Laser mirrors according to the various embodiments described herein can be generally used as a reflective device positioned within a hand piece or other housing for directing a laser beam to a treatment area. Different embodiments of a hand piece including a reflective device, and related structure are described in U.S. Patent Application Pub. No. US2013/0059264A1, the entire disclosure of which is hereby incorporated herein by reference.

In some embodiments described herein, the reflective device has a substantially non-transparent, thermally conductive and/or diffusive substrate, a reflective layer disposed above the substrate, and a coating with high surface hardness disposed over the reflective layer, wherein the combination of the reflective layer and the coating provide reflection of visible through infra-red wavelengths. Laser radiation at a wavelength approximately in the 9-10 μm range may be used for removal of hard tissue. Such laser radiation can be generated using various embodiments of a laser described in U.S. Patent Application Pub. No. 2011-0189628A1, the entire disclosure of which is hereby incorporated herein by reference.

A laser light at a wavelength of approximately 532 nm (green) or 630 nm (red) may be used for marking, e.g., for providing visual alignment of the treatment laser beam with the area/region to be treated. Lasers of other wavelengths in the visible spectrum may also be used as marking lasers. The power level of the marking laser can be limited to approximately 5 mW, and the power level of the treatment laser (e.g., a 9.3 μm laser) can be up to approximately 30 W.

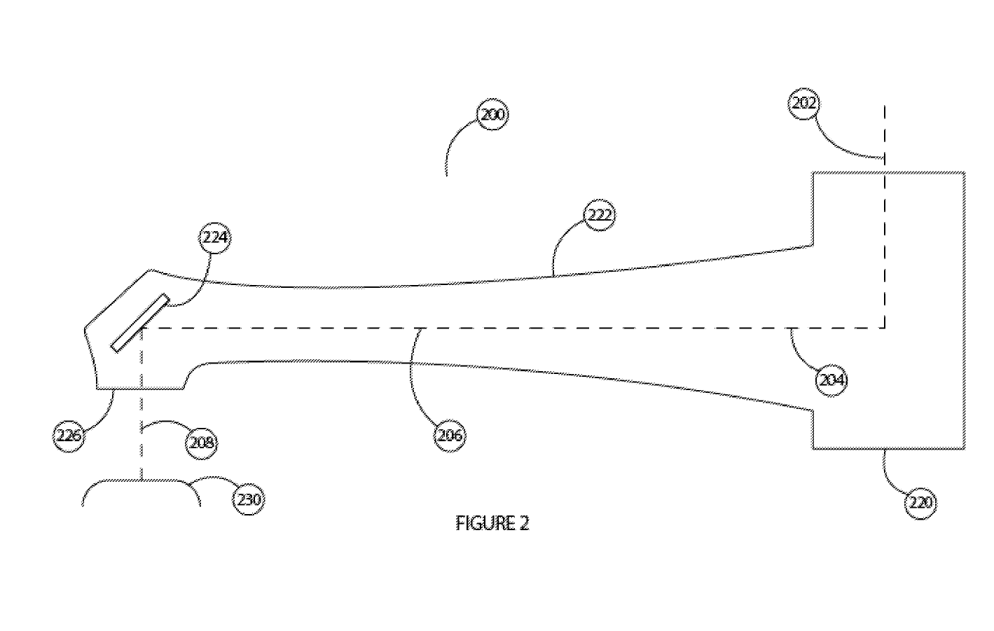

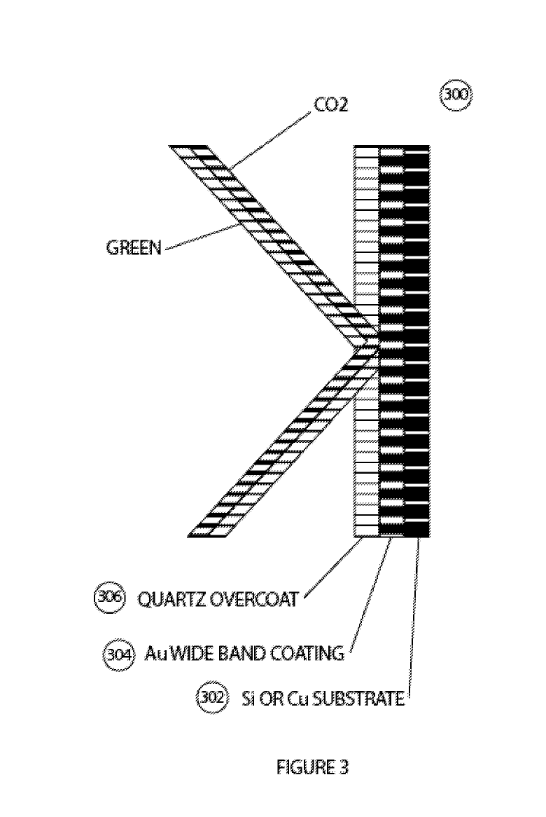

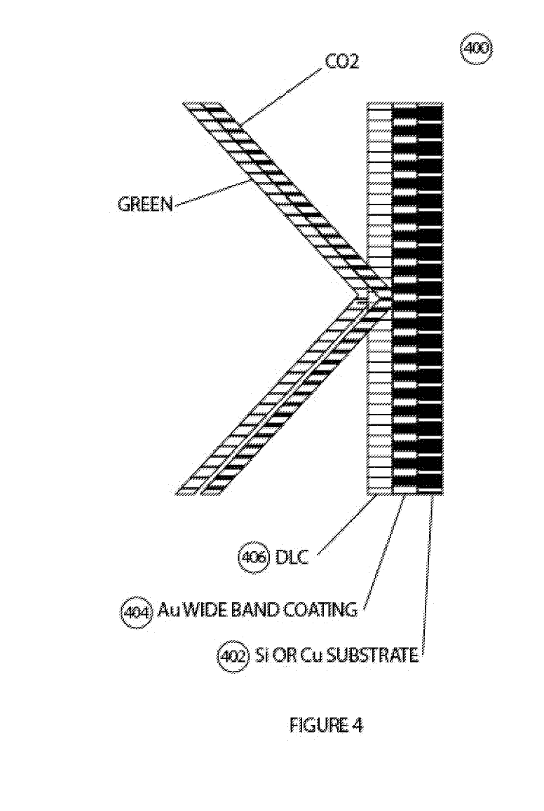

With reference to FIG. 2, in an exemplary laser-based dental treatment system 200, a laser beam 202 (which can be a treatment laser beam and/or a marking laser beam), is received in a housing/main chamber 220, and is directed along an axis 204 thereof. The laser beam 202 travels along a mating optical axis 206 of an affixed hand piece 222, and reflects off a turning mirror 224 located within the hand piece 222. The turning mirror 224 is generally centered on the mating optical axis 206 of the hand piece 222 at an angular orientation such that the laser beam 202 is reflected along an axis 208, through a beam exit 226, toward a treatment area 230. The turning mirror 224 can be constructed according to any of the different embodiments described below with reference to FIGS. 3 and 4.

With reference to FIG. 3, a mirror 300 according to one embodiment includes a silicon (Si) substrate 302, a wide-band reflective layer 304 (e.g., a silver or aluminum layer), and a quartz (SiO₄) protective layer 306. The wide-band layer 304 may include or consist essentially of gold. The particles of enamel are less likely to adhere to the quartz layer and are less likely to melt thereon. This can increase the time of use of the mirror for up to about 2 minutes. The silicon substrate thickness may be in the range of about 0.5 mm up to about 1.0 mm, though lesser and greater thicknesses are contemplated. The wide-band reflective layer 304 is deposited on the substrate 302 by plating or sputtering and may have a thickness of approximately 200 nm. Both lesser and greater thicknesses (e.g., 50 nm, 100 nm, 250 nm, etc.) are contemplated. The quartz protective layer 306 is deposited over the reflective layer 304 (e.g., by sputtering) and has a thickness of approximately 165 nm, though lesser and greater thicknesses (e.g., 40 nm, 80 nm, 200 nm, etc.) are within the scope of various embodiments. In some embodiments, the silicon substrate 302 is replaced with a copper substrate that can efficiently dissipate heat from the enamel particles, and may thus increase the time of use up to about 20 minutes. Various embodiments of quartz coated mirrors typically have reflectivity of up to about 98.5% for the 9.3 μm and 532 nm wavelengths. These embodiments do not include a reflective dielectric layer as such a layer can decrease the thermal conductivity/diffusivity of the mirror.

With reference to FIG. 4, a mirror 400 includes a silicon or a metal substrate 402. Metal (e.g., copper) substrates 402 can efficiently dissipate heat imparted to the mirror by any debris relative to heat dissipation through a silicon substrate. Other materials that are thermally diffusive (e.g., materials having greater thermal diffusivity than silicon, such as copper, carbon, graphite, gold, and silver, may be used to form the substrate. A silicon substrate (e.g., the substrate 402) may have a thickness in the range of about 0.5 mm up to about 1.0 mm, with a tolerance of e.g., 0.05 mm, 0.01 mm, etc. Larger and smaller thickness values e.g., 0.25 mm, 1.5 mm, 4 mm, etc.) are also within the scope of various embodiments. A copper substrate (e.g., the substrate 402) may also have a thickness in the range of about 0.5 mm up to about 1.0 mm, with tolerances described above, which can yield a lightweight substrate with sufficient mass to provide the necessary thermal conduction, diffusion, and/or heat sinking Larger and smaller thickness values, as described above, are contemplated in different embodiments.

Optionally, a reflective layer 404, e.g., a gold layer, is applied to the substrate e.g., through plating or sputtering. In some embodiments, a silver or aluminum layer may be used instead of a gold layer. Gold generally reflects infra-red wavelengths, e.g., 9.3 and 9.6 μm, more effectively than silver or aluminum. The thickness of the layer 404 may be in the range of about 100 nm up to about 100 μm.

If plating is used as a metal deposition process, an intermediary layer, e.g., a nickel layer, may be included between the substrate and the metallic reflective layer. The intermediary layer can improve adhesion of the metallic reflective layer to the substrate, without significantly (e.g., 2%, 5%, 10%, etc.) affecting the thermal conductivity and/or thermal diffusivity of the mirror structure. If the reflective layer is deposited by sputtering, which typically uses high energy for metal ion deposition, the bonding is significantly stronger relative to that achieved with plating and, as such, no intermediary layer may be required. An intermediary layer may nevertheless be included when the reflective metallic layer is deposited using sputtering. Sputtering may be advantages relative to plating, e.g., in terms of complexity and/or cost of manufacturing due to the improved bonding provided thereby, which can eliminate the need for an intermediary layer.

The metallic reflective layer 404 is then coated with a durable coating/layer 406, such as diamond-like carbon (DLC), quartz, or sapphire coating. The minimum hardness suitable as a protective coating/layer 406 for the mirrors according to various embodiments is generally greater than about 100 or greater than about 120 on the Knoop scale, where 100 is the hardness of zinc selenide, 820 is the hardness of quartz, 2100 is the hardness of sapphire, and 7000 is the hardness of diamond. While sapphire is substantially harder than quartz and can transmit (i.e., is substantially transparent to) light in the visible spectrum, a sapphire coating/layer can absorb substantially more radiation in the mid-to-far infra-red range, e.g., radiation at wavelengths in the range 8-12 μm, than DLC or quartz coatings, adversely affecting reflectivity of such radiation.

The coating/layer 406 may have a thickness between about 300 nm and 500 nm. In various embodiments, the coating/layer 406 can be less than 300 nm thick or can be more than 500 nm thick. A DLC coating is the hardest of the three types. DLC also has the highest thermal conductivity of the three coatings, typically in the range of 0.1-1.0 W/m·K. Of the three types of coating, quartz is the softest.

An additional coating of a hydrophobic material can be applied over the quartz or DLC layer (e.g., the coating/layer 406). Alternatively or in addition, the DLC or quartz coating (e.g., the coating/layer 406) can be made hydrophobic by doping a hydrophobic material into the quartz or DLC layer. Examples of suitable hydrophobic materials include fluorine compounds such as fluoro-alkyl silane (FAS). Hydrophobic characteristic of a surface can be described in terms of a water droplet angle. The doping of DLC with FAS can result in a water droplet angle of the layer 406 of up to about 80 degrees.

This can prevent or minimize adhering of any liquids, such as water splashing from the treatment region, spit, mist, or dirt and moisture from a compressed air flow over the mirror 300 to the mirror surface. Water or soap water or other cleaner may be used to blow off the mirror 300. The FAS layer and/or the FAS-doped layer 406 can resist cleaning solvents such as hexane and isopropyl alcohol so that the cleansing of the mirror 400 does not significantly damage the hydrophobic coating. Other fluorine compounds may be used if their hydrophobic and solvent resistance properties are similar to or better than FAS.

A DLC coating is generally transparent to infra-red wavelengths (e.g., 9.3 μm, 9.6 μm, etc.), and can reflect wavelengths corresponding to visible light, including the 532 nm wavelength of a marking laser. Thus, a layer of DLC (e.g., the layer 406) in combination with a gold layer underneath (e.g., the layer 404) can reflect both wavelengths in the visible-light spectrum (e.g., from about 360 nm up to about 780 nm, with a tolerance of 1 nm, 5 nm, 10 nm, 20 nm, etc.), and in the near infra-red spectrum (e.g., from about 780 nm up to about 12,000 nm, with similar tolerances as those described above).

If quartz or sapphire is used as a protective top layer (e.g., the coating/layer 406) instead of DLC, silver may be used to form the metallic reflective layer 404, because neither quartz nor sapphire tends to reflect visible light efficiently, and gold tends to reflect a relatively limited range of visible light than does silver. As wavelengths in the visible-light spectrum, including 532 nm wavelength of the marking laser, are transmitted through the quartz or sapphire coating, the reflectivity of visible light and the light of the marking laser may decrease by up to about 10% compared to the reflectivity achieved using a DLC coating. The decrease in reflectivity generally depends on the thickness of coating 406. The range of wavelengths reflected by mirrors according to these embodiments, nevertheless, is approximately 380 nm to 12,000 nm, with similar tolerances as those described above.

In some embodiments, the metallic substrate 402 is formed using silver, aluminum, gold, or other metal that can reflect light in the visible range and radiation in the mid-to-far infra-red range (e.g., in approximately 8-12 μm range). The metallic substrate 402 may be polished to increase its reflectivity in the visible light and/or mid-to-far infra-red ranges. The protective coating/layer 406, which may include a hydrophobic material and/or layer, may be disposed directly over the reflective substrate 402. Thicknesses and materials of the layers 402, 406 and polishing of the substrate 402 are selected such that the two layers in combination have an initial or peak reflectivity for wavelengths in the visible range (generally from about 380 nm up to about 720 or 780 nm) of approximately 50% or more, and in the mid/far infra-red range (typically from about 720 or 780 nm up to about 12,000 nm) of approximately 85% or more.

A mirror including a copper substrate, an infra-red reflective layer of gold, and a DLC layer as a protective and visible-light reflective layer, with a suitable fluorine compound such as FAS added to the DLC to increase hydrophobic properties of the DLC layer, can yield a wideband mirror with optimized debris resistance and thermal conduction properties, providing highly reliable performance in a dental laser hand piece or other laser-based applications.

In some embodiments, for use within an angled laser hand piece, the mirror 300 may be round, so that it can be attached to a threaded element and secured into a suitable location against a mechanical stop. Mirrors of other shapes (e.g., square, rectangular, etc.), and structured as described above with reference to FIGS. 2 and 3 can also be fabricated. The mirrors can be manufactured in sheets, which can then be cut into individual smaller mirrors which are shaped as needed for a specified application.

The peak reflectivity of the mirrors according to various embodiments in the visible light range and in the mid to far infrared (e.g., 8-12 μm) range can be at least 90%. During operation, the reflectivity may decrease down to about 50% when the reduced reflectivity can interfere with the delivery of the laser beam and cleansing or replacement of the mirror may be needed. Due to the choices of the substrate, the reflective layer, and the protective coating, mirrors according to the various embodiments described herein can maintain a reflectivity of at least 75% during a typical dental treatment session. As such, the lasing time of the mirror can be increased from about 1 minute (for a conventional mirror) up to about 2 minutes, 5 minutes, 10, minutes, and even up to about 20 minutes, within a tolerance of e.g., 1 s, 5 s, 10 s, 30 s, etc., for mirrors according to the various embodiments described herein.

Having described herein illustrative embodiments, persons of ordinary skill in the art will appreciate various other features and advantages of the invention apart from those specifically described above. Various combinations and permutations of the recited features, materials, and properties described herein are within the scope of the invention. It should therefore be understood that the foregoing is only illustrative of the principles of the invention, and that various modifications and additions can be made by those skilled in the art without departing from the spirit and scope of the invention. Accordingly, the appended claims shall not be limited by the particular features that have been shown and described, but shall be construed also to cover any obvious modifications and equivalents thereof

What is claimed is:

1. A reflective device disposable within a hand piece for directing a laser beam toward a treatment area, the reflective device comprising:
a substrate;
a first layer, disposed above the substrate; and
a second layer, disposed above the first layer, the second layer having a hardness of at least about 120 Knoop,
wherein the reflective device lacks a reflective dielectric layer and the combination of the first layer and the second layer provides reflection of light wavelengths ranging from about 380 nm to about 12,000 nm.

2. The device of claim 1, wherein the substrate comprises a thermally conductive material, being at least as thermally conductive as silicon.

3. The device of claim 2, wherein the material comprises copper.

4. The device of claim 1, wherein a thickness of the substrate is within a range from about 0.5 mm up to about 1.0 mm.

5. The device of claim 1, wherein the first layer comprises at least one of a gold layer and a silver layer.

6. The device of claim 1, wherein a thickness of the first layer is within a range from about 100 nm up to about 500 nm.

7. The device of claim 1, wherein the second layer comprises at least one material selected from the group consisting of a quartz layer, a sapphire layer, and a diamond-like-carbon (DLC) layer.

8. The device of claim 1, wherein the thickness of the second layer is within a range from about 50 nm up to about 500 nm.

9. The device of claim 1, wherein the first layer comprises a first material reflecting radiation within a first range of wavelengths, and the second layer comprises a second material reflecting radiation with a second, different range of wavelengths.

10. The device of claim 9, wherein the first range of wavelengths comprises wavelengths within a visible to infra-red range of wavelengths, and the second range of wavelengths comprises wavelengths of visible light.

11. The device of claim 1, wherein the second layer comprises a hydrophobic layer.

12. The device of claim 11, wherein the hydrophobic layer comprises fluoro-alkyl silane (FAS).

13. The device of claim 1, further comprising a metallic, adhesive layer disposed between the substrate and the first layer.

14. The device of claim 13, wherein the adhesive layer comprises nickel.

15. (canceled)

16. (canceled)

17. A method of manufacturing a reflective device disposable within a hand piece for directing a laser beam toward a treatment area, the method comprising:
bonding a non-adhesive, reflective layer to a substantially non-transparent, thermally conductive substrate; and
depositing a coating over the reflective layer, without a reflective dielectric layer therebetween, to configure the reflective device to reflect light wavelengths ranging from about 380 nm up to about 12,000 nm.

18. The method of claim 17, wherein the bonding step comprises at least one of plating and sputtering.

19. The method of claim 17, wherein the bonding step comprises:
plating an adhesive, intermediary layer to the substrate; and
plating the reflective layer to the intermediary layer.

20. The method of claim 17, further comprising adding a hydrophobic material to the coating.

21. A reflective device manufactured according to the method of claim 17.

22. (canceled)

23. (canceled)

24. A system for dental treatment, comprising:
a radio frequency (RF) excited CO₂ laser filled with gas at a pressure in a range of about 260 to 600 Torr, for generating a laser beam;
a hand piece in optical communication with the laser for directing the laser beam to a treatment area; and
a reflective device disposed within the hand piece, the reflective device comprising:
(i) a substrate;
(ii) a first layer, disposed above the substrate; and
(iii) a second layer, disposed above the first layer, the second layer having a hardness of at least about 120 Knoop,
wherein the reflective device lacks a reflective dielectric layer and the combination of the first layer and the second layer provides reflection of light wavelengths ranging from about 380 nm to about 12,000 nm.

25. A reflective device disposable within a hand piece for directing a laser beam toward a treatment area, the reflective device comprising:
a reflective substrate; and
a protective layer disposed over the substrate, the protective layer having a hardness of at least about 120 Knoop,
wherein the reflective device lacks a reflective dielectric layer and the combination of the substrate and the protective layer: (i) provides reflection of light at wavelengths ranging from about 380 nm up to about 12,000 nm, and (ii) has a reflectivity of at least about 50% at wavelengths ranging from approximately 380 nm up to approximately 720 nm and a reflectivity of at least about 85% at wavelengths ranging from approximately 720 nm up to approximately 12,000 nm.
